(19) United States
(12) Patent Application Publication
(10) Pub. No.: US 2006/0086262 A1
(43) Pub. Date: Apr. 27, 2006

(54) Apparatus for processing oranic substance

(75) Inventors: Yong Gu Kim, Seoul (KR); Tae Hee Kwak, Incheon (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/119,900

(22) Filed: May 3, 2005

(30) Foreign Application Priority Data
Oct. 7, 2004 (KR) P2004-79912

(51) Int. Cl. B30B 9/02

(52) U.S. Cl. 100/37

(57) ABSTRACT

The present invention provides an apparatus for processing organic substances such as food and the like, by which time and costs for processing the organic substances are reduced to enhance performance of processing the organic substances. The present invention includes a dewatering means for separating moisture from inputted inorganic substances and a drying means provided to one side of the dewatering means for drying the inorganic substances discharged from the dewatering means.

This application claims the benefit of the Korean Application No. P2004-79912 filed on Oct. 7, 2004, which is hereby incorporated by reference.

### BACKGROUND OF THE INVENTION

1. Field of the Invention

The present invention relates to an apparatus for processing organic substances such as food and the like, by which performance of processing organic substances is enhanced.

2. Discussion of the Related Art

Generally, an organic substance handling apparatus is to process organic substances by reducing weight and volume of the organic substances and is further to restrain the generation of stink, insects and the like to maintain hygienic environment of processing organic substances.

A garbage processing device among the above-functioning organic substance processing apparatuses according to a related art is explained as follows.

The related art garbage processing device is mainly categorized into a heat & dry type and a fermentation type using a microbic biochip.

The heat & dry type garbage processing device is to reduce a volume of garbage in a manner of evaporating moisture of garbage with radiation heat generated from a heat source such as an electrical heater to dry the garbage.

For this, a fan enforcing a flow of air is additionally provided to the heat source such as the electrical heater and the like of the heat & dry type garbage processing device, whereby hot air evaporates moisture of the garbage.

Hence, in the heat & dry type garbage processing device, the evaporated moisture is discharged outside by the driven fan to process the garbage and to reduce a volume of the garbage.

However, the related art heat & dry type garbage processing device has the following problems.

First of all, the related art heat & dry type garbage processing device processes the garbage using high-temperature radiation heat and hot air, whereby the garbage processing takes a considerable time to lower garbage processing performance.

Secondly, the related art heat & dry type garbage processing device needs to drive the electrical heater and the fan for a considerably long time to process the garbage, whereby the maintenance cost according to power consumption is raised.

Thirdly, the related art fermentation type garbage processing device needs to keep being replenished with biochips, whereby the maintenance cost is raised and whereby the garbage processing takes a considerable time to lower garbage processing performance.

### SUMMARY OF THE INVENTION

Accordingly, the present invention is directed to an apparatus for processing organic substances that substantially obviates one or more problems due to limitations and disadvantages of the related art.

An object of the present invention is to provide an apparatus for processing organic substances such as food and the like, by which time and costs for processing the organic substances are reduced to enhance performance of processing the organic substances.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for processing inorganic substances according to the present invention includes a dewatering means for separating moisture from inputted inorganic substances and a drying means provided to one side of the dewatering means for drying the inorganic substances discharged from the dewatering means.

Preferably, the dewatering means includes a housing having an inorganic substance input portion and an inorganic substance discharge portion and a pressurizing part received within the housing to separate the moisture from the inorganic substances by pressurizing the inorganic substances inputted via the inorganic substance input portion.

More preferably, the pressurizing part includes a pressurizing member pressurizing the inorganic substances inputted to the housing and a drive part connected to the pressurizing member to move the pressurizing member.

More preferably, the pressurizing member includes a multitude of perforated holes enabling water communications.

More preferably, the pressurizing part further includes a mesh provided to one side of the pressurizing member to prevent the inorganic substances pressurized by the pressurizing member from being introduced into the perforated holes.

More preferably, the drive part includes a pinion rotated by a motor and a rack engaging with the pinion to provide a straight-line motion to a rod connected to the pressurizing member.

More preferably, the inorganic substance discharge portion includes a door selectively open/closed.

More preferably, the door is open if a pressure of the inorganic substances working on the pressurizing part is equal to or greater than a predetermined pressure.

More preferably, the pressurizing member includes a pressure sensor.

More preferably, the door is rotatably connected to one side of the inorganic substance discharge portion.

More preferably, wherein the door is open/closed by a sliding system.

Preferably, the drying means includes a drying container storing the inorganic substances discharged from the dewatering means and a heating part supplying heat to the inorganic substances received within the drying container.

More preferably, the drying container includes a drying chamber receiving the inorganic substances therein to dry and a heat supply chamber receiving the heating part therein.

More preferably, the heating part includes a heater provided to the heat supply chamber.

More preferably, the drying means further includes a heat supply fan supplying heat generated from the heater to the drying chamber.

More preferably, the drying means further includes an agitator provided within the drying container to agitate the inorganic substances stored in the drying container.

More preferably, the drying container includes a gas discharge portion discharging gas generated from the grinded inorganic substances.

More preferably, the drying means further includes a gas discharge pipe connected to the gas discharge portion to discharge the gas.

More preferably, the drying means further includes a deodorizing part provided to one side of either the drying container or the gas discharge pipe to remove stink of the gas.

More preferably, the apparatus further includes a guide guiding the inorganic substances discharged from the dewatering means to the drying container.

Therefore, by the above-configured apparatus for processing the organic substances, time and costs for processing the organic substances are reduced and the performance of processing the organic substances is enhanced.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of an apparatus for processing organic substances according to one embodiment of the present invention;

FIG. 2 is a front diagram of a pressurizing member provided to a dewatering device of the apparatus in FIG. 1;

FIGS. 3A to 3C are cross-sectional diagrams for explaining operations of the organic substance processing apparatus in FIG. 1;

FIG. 4 is a cross-sectional diagram of an apparatus for processing organic substances according to another embodiment of the present invention; and

FIG. 5A and FIG. 5B are cross-sectional diagrams for explaining operations of the organic substance processing apparatus in FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

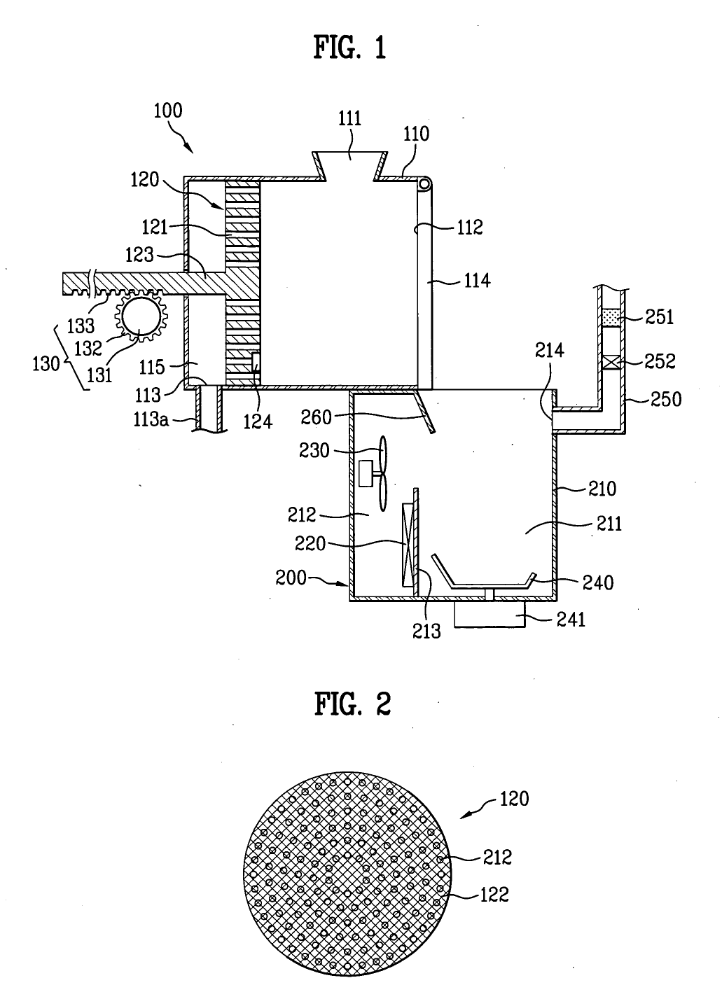

First of all, an apparatus for processing organic substances according to one embodiment of the present invention is explained with reference to FIG. 1 and FIG. 2 as follows.

The apparatus for processing the organic substances is an apparatus for processing organic substances including garbage and the like by a heat & dry method, and more particularly, an organic substance processing apparatus that processes organic substances in a manner of dewatering the organic substances inputted thereto and drying the dewatered organic substances.

Referring to FIG. 1 and FIG. 2, an apparatus for processing organic substances includes a dewatering device 100 for separating moisture from the organic substances inputted thereto and a drying device 200 provided to one side of the dewatering device 100 to dry the organic substances discharged from the dewatering device 100.

The dewatering device 100 includes a housing 110 having an organic substance input portion 111 and an organic substance discharge portion 112 and a pressurizing part pressurizing the organic substances inputted to the housing 110 via the organic substance input portion 111.

Preferably, the organic substance input portion 111 is provided to one upper side of the housing 110. And, the organic substance discharge portion 112 is provided to a rear side of the housing 110, for example.

The pressurizing part is configured to separate moisture from inorganic substances by pressurizing the inorganic substances within the housing 110. The moisture, i.e., water separated from the organic substances within the housing 110 by the pressurizing part is discharged via a water discharge opening 113 provided to a one lower side of the housing 110.

Specifically, the inorganic substance input portion 111 is provided to an upper rear side of the housing 110, the water opening 113 is provided to a front bottom side of the housing 110, and a water discharge pipe 113a is connected to the water discharge opening 113.

The pressurizing part is provided movable within the housing 110 in a back-and-forth direction. And, the pressurizing part includes a pressurizing member 120 pressurizing the inorganic substances within the housing 110 and a drive part 130 moving the pressurizing member 120.

The pressurizing member 120 is configured to have the same shape of an interior of the housing 110. And, a multitude of small perforated holes 121 perforating the pressurizing member 120 in the back-and-forth direction are provided to the pressurizing member 120 to allow the moisture separated from the organic substances to pass through.

Preferably, to prevent the inorganic substances pressurized by the pressurizing member 120 from being introduced into or passing through the perforated holes 121, a mesh 122 is provided to a backside of the pressurizing member 120.

Alternatively, instead of providing the perforated holes to the pressurizing member 120, an inner drum (not shown in the drawing) having perforated holes therein can be provided within the housing 110.

In such a case, as the inorganic substances received within the drum is pressurized, the moisture separated from the inorganic substances received in the drum is discharged into a space between the housing 110 and the drum via the perforated holes of the drum to be discharged outside via the water discharge hole.

Preferably, a mesh is provided to an inner wall of the drum.

Alternatively, a dewatering system using a centrifugal force can be employed instead of the system of separating the moisture by pressurizing the inorganic substances received within the drum.

The drive part 130 includes a pinion 132 rotatably connected to a rotational shaft 131 of a motor and a rack 133 engaging with the pinion 132.

The rack 133 transforms a rotary motion of the pinion 132 into a straight-line motion so that a rod 123 connected to a front side of the pressurizing member 120 to move in the back-and-forth direction.

Alternatively, instead of the rack and pinion 133 and 132, an oil pressure cylinder (not shown in the drawing) or a connecting rod (not shown in the drawing) connected to a crankshaft can be provided.

In the rod 123 explained in the description of the embodiment of the present invention, the rack 133 is built in one body of a front end and a front side of the pressurizing member is-connected to a rear end, which can be modified as well.

Meanwhile, the organic substance discharge portion 112, which is provided to the rear side of the housing 110, is configured to be selectively opened or closed by a door 114.

The door 14 keeps being closed while the inorganic substances within the housing 110 are pressurized by the pressurizing member 120. Once the pressurization of the inorganic substances by the pressurizing member is completed, the door 114 is opened so that the inorganic substances within the housing 110 are discharged toward the drying device 200.

For this, the door 114 is rotatably coupled with one side of the inorganic substance discharge portion 112, and more particularly, with an upper rim thereof to be opened/closed.

Preferably, the door 114 is configured to be opened if a pressure of the inorganic substances working on the pressurizing part, and more particularly, on the pressurizing member 120 is equal to or greater than a predetermined pressure.

For this, a pressure sensor 124 is provided to one side of the pressurizing member 120, and more preferably, to a rear side of the pressurizing member 120 to detect the pressure applied to the pressurizing member 120.

Accordingly, if the pressure detected by the pressure sensor 124 becomes equal to or greater than the predetermined pressure, the door 114 is opened by a door-turning motor (not shown in the drawing) so that the inorganic substances are discharged toward the drying device 200.

Alternatively, the pressure sensor 124 can be provided to either a lateral inside of the door or a lateral rear inside of the housing 110.

By the above configuration, a water discharge space 115 is formed between a lateral front inside of the housing 110 and a front side of the pressurizing member 120 to discharge moisture separated from the inorganic substances.

In order for the inorganic substances inputted via the inorganic substance input portion 111 not to be discharged via the water discharge opening 113, a front limit line of the pressurizing member 120 is preferably situated in rear of the water discharge opening 113.

Meanwhile, the drying device 200 includes a drying container 210 storing the inorganic substances discharged from the dewatering device 100 and a heating part 220 supplying heat to inorganic substances received within the drying container 210.

In this case, the drying container 210 is provided under the housing 110, and more particularly, under the organic substance discharge portion 112. The drying container 210 can have one of various shapes such as a cylinder, a rectangular box and the like.

Specifically, the drying container 210 includes a drying chamber 211 receiving to dry the organic substances discharged from the organic substance discharge portion 112 and a heat supply chamber 213 having the heating part 220 received therein.

For this, a partition wall 213 having a predetermined height is provided to a bottom of the drying container 210 to partition the drying chamber 211 and the heat supply chamber 212 from each other.

Preferably, the partition wall 213 is provided in front of an extending line downwardly extending from the organic substance discharge portion 112 of the housing 110.

The heating part 220 includes a heater provided to a front side of the partition wall 213.

In this case, a heat supply fan 230 supplying hot air heated by the heater to the drying chamber 211 is provided over one upper side of the heater to enhance performance of drying the organic substances received within the drying chamber 211.

Moreover, the heat supply fan 230 is capable of discharging gas including stink generated from drying the garbage externally.

Alternatively, the heating part 220 can be provided to a sidewall of the drying container 210. Specifically, the heating part 220 may include an electrical heater wound up on an outer circumference of the drying container 210 to generate heat by power supply and to adhere closely to an outer circumference of the drying container 210.

In this case, the drying container needs not to be provided with the heat supply chamber 212.

Moreover, an agitator 240 agitating the inorganic substances is provided within the drying container 210, and more particularly, to the drying chamber 211 to efficiently dry the grinded inorganic substances with the heat generated from the heating part 220.

The agitator 240 is connected to an agitator motor 241 provided under the drying container 210 and is rotated to agitate inorganic substances stored in the drying container 210.

Namely, the agitator 240 is preferably configured to be rotated in the process of drying the grinded inorganic substances received in the drying container 210 by the heating part 220.

Alternatively, an agitator (not shown in the drawing) can be provided within the drying container 210 to agitate the inorganic substances by a vibration system.

A gas discharge portion 214 is provided to the drying container 210 to discharge gas generated from the grinded organic substances, i.e., gas including steam evaporated by the heating part 220.

The gas discharge portion 214 is preferably provided to an upper lateral side of the drying chamber 211.

In case of being provided to a lower lateral side of the drying chamber 211, the gas discharge portion 214 can be blocked by the inorganic substances.

And, a gas discharge pipe 250 is connected to the gas discharge portion 214 to guide the gas outside.

Preferably, a deodorizing part 251 is provided to the gas discharge pipe 250 to remove the smell included in the externally discharged gas.

Alternatively, the deodorizing part 251 can be provided to the drying container 210, and more particularly, to the gas discharge part 214.

Preferably, a deodorizing heater 252 is further provided to the gas discharge pipe 250 to primarily remove the stink by heating the discharged gas at high temperature.

The deodorizing heater 252 is provided between the gas discharge portion 214 and the deodorizing part 251.

Accordingly, once the exhaust gas is primarily heated by the deodorizing heater 252, the deodorizing part 251 removes the stinks secondarily to enable clean air to be discharged outside.

Preferably, an exhaust fan (not shown in the drawing) is further provided to the gas discharge pipe 250 to smooth the discharge of the gas.

Meanwhile, a guide portion 260 guiding the inorganic substances discharged from the inorganic substance discharge portion 112 to the drying chamber 211 is provided to the organic substance processing apparatus according to the present invention.

In this case, an upper end of the guide portion 260 is connected to a ceiling of the drying container 210 and a lower end is situated in rear of an extending line extending downward from the organic substance discharge portion 112. Hence, the guide portion 260 extends downward by a predetermined slope.

Accordingly, the inorganic substances discharged from the inorganic substance discharge portion 112 are introduced into the drying chamber 211 by the guide portion 260 and are prevented from entering the heat supply chamber 212.

Moreover, the guide portion 260 is operative in guiding air, which is heated by the heating part 220 to be blown by the heat supply fan 230 to the drying chamber 211.

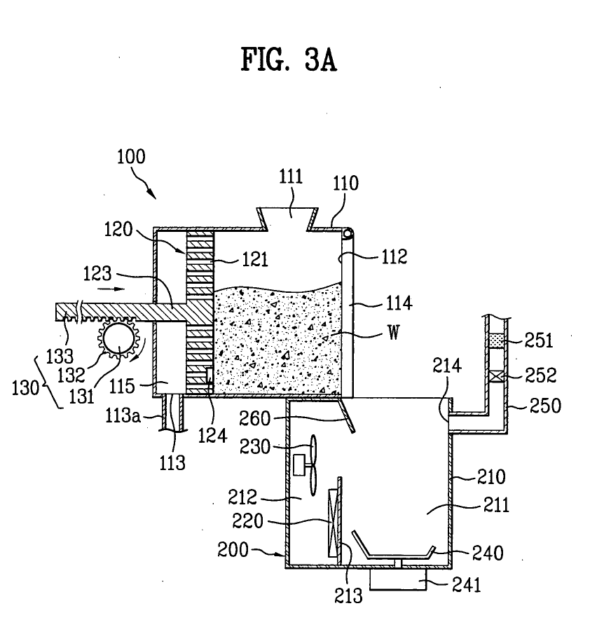

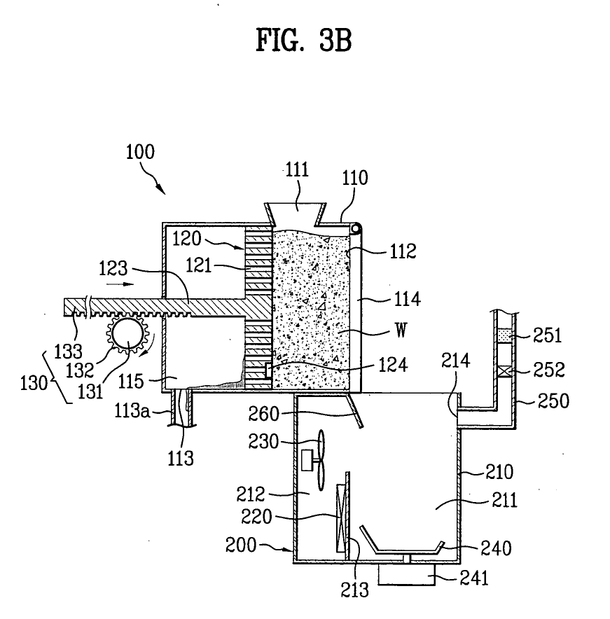

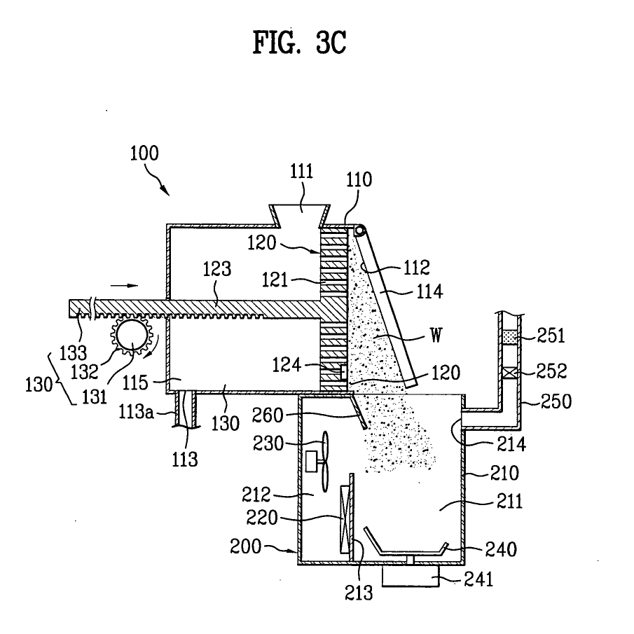

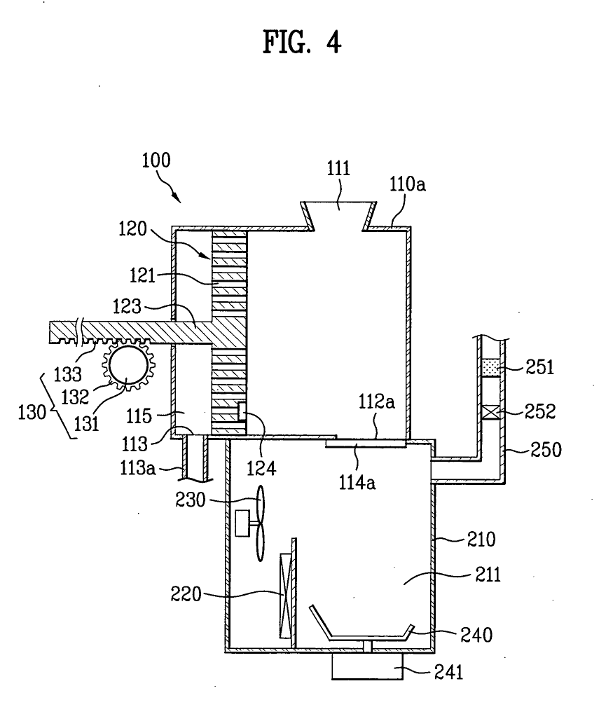

A process that the garbage W is processed by the above-described inorganic substance processing apparatus according to one embodiment of the present invention is explained with reference to FIGS. 3A to 3C is explained as follows.

First of all, once a user inputs the garbage to the housing 110 via the inorganic substance input portion 111, the garbage W is held in the dewatering space provided between the pressurizing member 120 and the rear inner wall of the housing 110.

If the pinion 132 is rotated to move the rack 133 in a rear reaction, the rod 123 moves the pressurizing member 120 in the rear direction. In doing so, the inorganic substance input portion 111 is cut off not to have the garbage W, which is pressurized by the pressurizing member 120, flow backward.

Hence, the garbage W held within the housing 110 is gradually pressurized by the pressurizing member 120 so that water involved in the garbage W is moved to the water discharge space 115 via a multitude of the perforated holes 121 formed at the pressurizing member 120. The moved water is then discharged outside via the water discharge pipe 113a.

If the pressure detected by the pressure sensor 124 provided to the pressurizing member 120 reaches the predetermined pressure, the door 114 is rotated counterclockwise to be open. And, the pressurizing member 120 keeps being moved to a rear end of the housing by the drive part 130 to discharge the garbage W toward the drying device 200 via the inorganic substance discharge portion 112.

Once the garbage W discharged via the inorganic substance discharge portion 112 is guided by the guide portion 260 to be held within the drying chamber 211, the heating part 220 and the heat supply fan 230 are driven to dry the garbage W.

In doing so, the agitator 240 agitates the garbage held within the drying chamber 211 to shorten a drying time of the garbage W.

And, the stinks separated from the garbage W is removed by the deodorizing heater 252 and the deodorizing part 251 in the process of being discharged via the gas discharge pipe 250.

Hence, weight and volume of the garbage initially inputted via the inorganic substance input portion 111 are minimized.

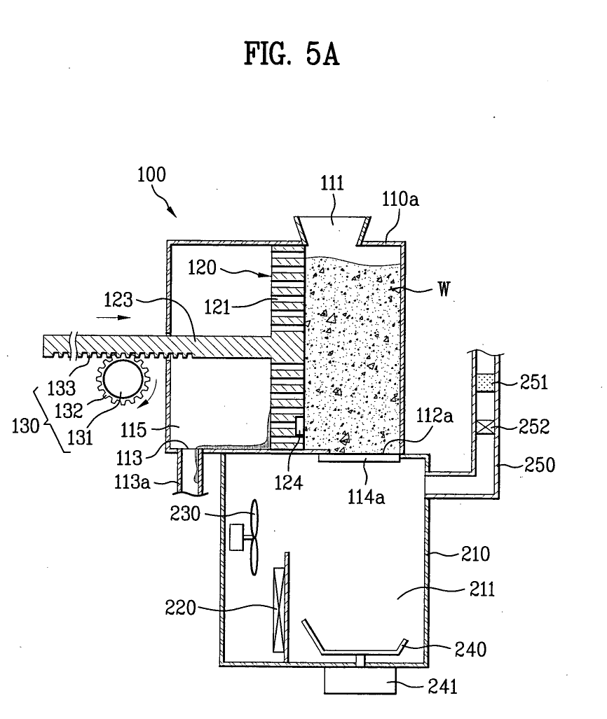

An apparatus for processing inorganic substances according to another embodiment of the present invention is explained with reference to FIG. 4 as follows.

In describing the apparatus according to the another embodiment of the present invention, the same reference numbers for the like parts of the former embodiment of the present invention are used and their explanation is not repeated.

Compared to the apparatus according to the former embodiment of the present invention, the apparatus according to the latter embodiment of the present invention modifies a structure of a housing 110a configuring a space for pressurizing to dehydrate inorganic substances.

Specifically, the housing 110a provided to an apparatus for processing organic substances according to another embodiment of the present invention is configured to downwardly discharge the dehydrated inorganic substances.

For this, an inorganic substance discharge portion 112a for discharging the inorganic substances is provided to a rear bottom of the housing 110a.

And, a door 114a selectively opened/closed is provided to the inorganic substance discharge portion 112a.

The door 114a is rotated to be open/closed like that of the former embodiment of the present invention. Alternatively, the door 114a of the present embodiment slides to be open/closed.

Namely, if the pressure detected by the pressure sensor 124 provided to the pressurizing member 120, which is explained in the former embodiment of the present invention, becomes equal to or greater than the predetermined pressure, the door 114a slides to one side of the inorganic substance discharge portion 112a to be open.

For this, a device, e.g., a rack and pinion, for transforming a rotational motion of a motor (not shown in the drawing) into a straight-line motion of the door 114a is provided under the housing 110a.

And, the drying container 210 is installed so that the drying chamber 211 is situated under the inorganic substance discharge portion 112a. Alternatively, the drying container 210 can be provided in various ways.

Namely, if a guide portion (not shown in the drawing) for guiding inorganic substances discharged from the inorganic substance discharge portion 112a is provided like the guide portion 260 of the former embodiment of the present invention, it is apparent that a location of the drying container 210 can be changed.

Moreover, the door opening/closing the inorganic substance discharge portion 112a can be installed to play a role as the guide portion in direct. In such a case, a door (not shown in the drawing) rotated to be open at a predetermined angle is preferably provided to the inorganic substance discharge portion 112a.

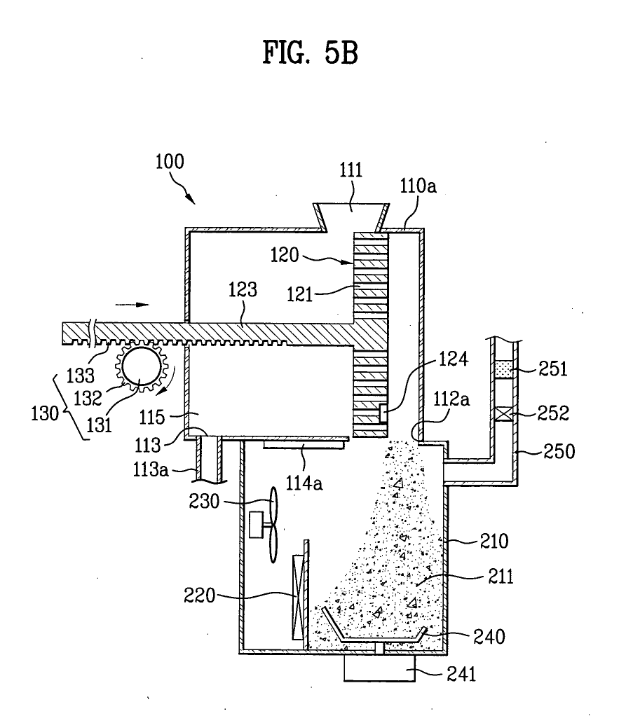

The rest parts of the present embodiment are like those of the former embodiment of the present invention, and their explanations are skipped. A process that garbage is processed by the inorganic substance processing apparatus according to another embodiment of the present invention is explained with reference to FIG. 5A and FIG. 5B as follows.

First of all, once a user inputs garbage W to the housing 110a via the inorganic substance input portion 111, the garbage W is held in the dewatering space provided between the pressurizing member 120 and a rear inner wall of the housing 110a.

If the pinion 132 is rotated to move the rack 133 in a rear reaction, the rod 123 moves the pressurizing member 120 in the rear direction.

Hence, the garbage W held within the housing 110a is gradually pressurized by the pressurizing member 120 so that water involved in the garbage W is moved to the water discharge space 115 via a multitude of the perforated holes 121 formed at the pressurizing member 120. The moved water is then discharged outside via the water discharge pipe 113a.

If the pressure detected by the pressure sensor 124 provided to the pressurizing member 120 reaches the predetermined pressure, the door 114 provided to the inorganic substance discharge portion 112a slides to be open. And, the garbage W is discharged to the drying chamber 211 via the inorganic substance discharge portion 112a.

Once the garbage W discharged via the inorganic substance discharge portion 112a is guided by the guide portion 260 to be held within the drying chamber 211, the heating part 220 and the heat supply fan 230 are driven to dry the garbage W.

Subsequent steps are as good as those of the former embodiment of the present invention, and their explanations are skipped.

Accordingly, the apparatus for processing the inorganic substances according to the present invention has the following effects or advantages.

First of all, the inorganic substance processing apparatus according to the present invention is provided with the dewatering device for removing the moisture from the inorganic substances sufficiently prior to the drying course of the inorganic substances, thereby reducing the drying time of the inorganic substances, i.e., the processing time of the inorganic substances and to enhance inorganic substance processing performance.

Secondly, the inorganic substance processing apparatus according to the present invention is provided with the agitator evenly agitating the inorganic substances to dry the grinded or pulverized inorganic substances in a short time, thereby shortening the inorganic substance processing time.

Thirdly, the inorganic substance processing apparatus according to the present invention shortens the drying time of the inorganic substances, thereby reducing power consumption needed to dry the inorganic substances.

Fourthly, the inorganic substance processing apparatus according to the present invention enhances the performance of removing the moisture from the inorganic substances, thereby reducing the weight of the inorganic substances smoothly.

Finally, the inorganic substance processing apparatus according to the present invention is provided with the deodorizing part for deodorizing the stink involved in the inorganic substances, thereby providing hygienic and pleasant environment to a user.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for processing inorganic substances, comprising:
a dewatering means for separating moisture from inputted inorganic substances; and
a drying means provided to one side of the dewatering means for drying the inorganic substances discharged from the dewatering means.

2. The apparatus of claim 1, the dewatering means comprising:
a housing having an inorganic substance input portion and an inorganic substance discharge portion; and
a pressurizing part received within the housing to separate the moisture from the inorganic substances by pressurizing the inorganic substances inputted via the inorganic substance input portion.

3. The apparatus of claim 2, the pressurizing part comprising:
a pressurizing member pressurizing the inorganic substances inputted to the housing; and
a drive part connected to the pressurizing member to move the pressurizing member.

4. The apparatus of claim 3, the pressurizing member comprising a multitude of perforated holes enabling water communications.

5. The apparatus of claim 4, the pressurizing part further comprising a mesh provided to one side of the pressurizing member to prevent the inorganic substances pressurized by the pressurizing member from being introduced into the perforated holes.

6. The apparatus of claim 3, the drive part comprising:
a pinion rotated by a motor; and
a rack engaging with the pinion to provide a straight-line motion to a rod connected to the pressurizing member.

7. The apparatus of claim 2, the inorganic substance discharge portion comprising a door selectively open/closed.

8. The apparatus of claim 7, wherein the door is open if a pressure of the inorganic substances working on the pressurizing part is equal to or greater than a predetermined pressure.

9. The apparatus of claim 8, the pressurizing member comprising a pressure sensor.

10. The apparatus of claim 7, wherein the door is rotatably connected to one side of the inorganic substance discharge portion.

11. The apparatus of claim 7, wherein the door is open/closed by a sliding system.

12. The apparatus of claim 1, the drying means comprising:
a drying container storing the inorganic substances discharged from the dewatering means; and
a heating part supplying heat to the inorganic substances received within the drying container.

13. The apparatus of claim 12, the drying container comprising:
a drying chamber receiving the inorganic substances therein to dry; and
a heat supply chamber receiving the heating part therein.

14. The apparatus of claim 13, the heating part comprising a heater provided to the heat supply chamber.

15. The apparatus of claim 14, the drying means further comprising a heat supply fan supplying heat generated from the heater to the drying chamber.

16. The apparatus of claim 12, the drying means further comprising an agitator provided within the drying container to agitate the inorganic substances stored in the drying container.

17. The apparatus of claim 12, the drying container comprising a gas discharge portion discharging gas generated from the grinded inorganic substances.

18. The apparatus of claim 17, the drying means further comprising a gas discharge pipe connected to the gas discharge portion to discharge the gas.

19. The apparatus of claim 18, the drying means further comprising a deodorizing part provided to one side of either the drying container or the gas discharge pipe to remove stink of the gas.

20. The apparatus of claim 12, further comprising a guide guiding the inorganic substances discharged from the dewatering means to the drying container.
